(19) United States
(12) Patent Application Publication
(10) Pub. No.: US 2024/0304381 A1
(43) Pub. Date: Sep. 12, 2024

(54) FILTER-CHOKE, PRODUCTION METHOD THEREOF AND ELECTRICAL DEVICE

(71) Applicant: SMA Solar Technology AG, Niestetal (DE)

(72) Inventors: Marek Rylko, Bielsko-Biala (PL); Marcin Kacki, Zegocina (PL); Adam Tobiasz, Roznów (PL); Przemyslaw Habinka, Krakow (PL)

(21) Appl. No.: 18/665,988

(22) Filed: May 16, 2024

Related U.S. Application Data
(63) Continuation of application No. PCT/EP2022/080359, filed on Oct. 31, 2022.

(30) Foreign Application Priority Data
Nov. 17, 2021 (EP) 21208886.8
May 31, 2022 (EP) 22176294.1

(51) Int. Cl. H01F 27/32; H01F 27/26; H01F 27/30; H01F 37/00

(52) U.S. Cl. CPC H01F 27/325; H01F 27/263; H01F 27/306; H01F 37/00

(57) ABSTRACT

The application discloses a filter-choke to be used in an EMI filter that includes a closed magnetic core having two core-legs, wherein the magnetic core is configured to be assembled out of at least two core-segments, at least two bobbins, each bobbin having a base flange and a tubular section extending in perpendicular direction from the base flange, wherein the tubular section has an opening for receiving one of the two core-legs, and a coil formed by an electric conductor having multiple windings arranged around the tubular section of each bobbin.

### REFERENCE TO RELATED APPLICATIONS

This application is a Continuation of International Application number PCT/EP2022/080359, filed on Oct. 31, 2022, which claims the benefit of European Application number 21208886.8, filed on Nov. 17, 2021 and European Application number 22176294.1, filed on May 31, 2022. The contents of the above-referenced patent applications are hereby incorporated by reference in their entirety.

### FIELD

The present disclosure relates to a filter-choke for use in an Electro-Magnetic-Interference-(EMI) filter.

### BACKGROUND

Various electrical devices, for instance Switch-Mode-Power-Supplies, are typically emitting electromagnetic radiation during their normal operation. In order to reduce that electromagnetic radiation, at least down below values defined in relevant electrical standards, an EMI filter typically is implemented within the device. Thus, the EMI filter is a necessary component to ensure an Electro-Magnetic-Compatibility (EMC) of the device during its operation. The EMI filter comprises a filter-choke which, dependent on the radiation mode to be filtered, can be configured as a differential mode filter-choke or as a common-mode filter-choke.

The filter-choke can comprise a magnetic core and at least two coils, each coil comprising an electric conductor that is arranged around a leg of the magnetic core in form of one or more windings. Since it is a frequent requirement that the magnetic core comprises a low magnetic reluctance, the core is designed as a closed magnetic core in form of a one-piece component. In that case, the coil is typically produced by manually winding the electrical wire around the magnetic core. However, the manual production process is relatively labor intensive, in particular, when an electrical wire with a large cross section area is to be used, which typically is the case when a low ohmic resistance of the electrical conductor is required. In addition, the manual production process results in a relatively poor reproducibility within multiple filter-chokes produced one after the other and theoretically comprising the same design. It also leads to an increase in component size. Therefore, it is desired to provide an optimized design for a filter-choke.

The printed document CN 203858954 U discloses a choke comprising an iron core set, two winding frames, a partition piece, and a winding. The iron core set comprises a first iron core and a second iron core. The two ends of the first iron core and the two ends of the second iron core are connected in a separable mode to form a closed shape. Each winding frame comprises a winding frame body which is provided with an iron core passageway allowing the iron core set to penetrate through. The partition piece can be fixed to and combined with the two winding frames. The winding is wound on the two winding frames.

The published document JP 6458720 B2 discloses a reactor consisting of a core and a bobbin comprising a coil that is disposed around the core. The bobbin consists of a first body part and a second body part. The first body part consists of: a first flange including an opening that is penetrated by the core; a first cylindrical member that is disposed on one side face of the first flange; and a first arm member. The second body part consists of: a second flange including an opening that is penetrated by the core; a second cylindrical member that is disposed on one side face of the second flange; and two second arm members. The bobbin is formed by fitting the first arm member between the two second arm members.

The published document JP H05 62020 U discloses a structure comprising an assembly out of a terminal block and a bobbin. The assembly is structured such that a plurality of locking projections are provided on a winding frame. A locking recessed part and a projecting part are used to engage and fix the winding frame and another winding frame, or the winding frame and the terminal block. Thereby, a bobbin is provided that combines a bobbin part having one section or a plurality of sections with a terminal block having various pins.

### SUMMARY

It is the object of the present disclosure to provide a filter-choke for use in an EMI filter addressing and eliminating or reducing at least one of the abovementioned drawbacks. Particularly, the filter-choke shall comprise highly reproducible magnetic properties within multiple filter-chokes manufactured according to the same design in combination with an easy way of assembly.

According to the present disclosure, a filter-choke to be used in an EMI filter comprises a closed magnetic core having two core-legs, wherein the magnetic core is configured to be assembled out of at least two core-segments, and at least two bobbins, wherein each bobbin comprises a base flange and a tubular section extending in perpendicular direction from the base flange, wherein the tubular section comprises an opening for receiving a first one of the two core-legs. The filter-choke further comprises a coil formed by an electric conductor having multiple windings arranged around the tubular section of each bobbin. The filter-choke has properties, wherein in one embodiment one of the at least two bobbins is configured such that the coil in a pre-wound status thereof is attachable, in particular attachable along an axial direction of the tubular section, on the tubular section of the respective one of the at least two bobbins. In addition, in an assembled state of the filter-choke the bobbins are arranged in a stacked manner, such that their openings are aligned coaxially to each other, and one of the core-legs extends through the openings. Further each bobbin comprises at least two first fitting elements arranged on opposite edges of its base flange. In the assembled state of the filter-choke the first fitting elements of the first bobbin are configured to engage with the first fitting elements of the adjacently arranged second bobbin for releasably fixing the two bobbins together. Therefore, in an assembled state of the filter-choke the coil is arranged between the base flanges of the adjacent bobbins, that is the first bobbin and its adjacent second bobbin. The arrangement of the coil between the base flanges of the adjacent bobbins can be such, that in an assembled state of the filter-choke the coil is slightly pressed in an axial direction thereof by the base flanges of the adjacent bobbins. Via this pressing the filter-choke in its assembled or preassembled status can be mechanically stabilized in an increased manner relative to an absent pressing of the coil. Therefore, also a reproducibility of the magnetic properties of the filter-choke in general, and, in particular, also during its handling can be optimized.

The feature that one of the at least two bobbins is configured such that the coil in a pre-wound status thereof is attachable on the tubular section of the respective one of the at least two bobbins can comprise the ability of a sliding-and guided-movement of the coil on its respective tubular section, at least in a non-final-assembled status of the filter choke. For example, at least that end of the tubular section, on which the coil is plugged on, is free of any barrier that prevents the attachment of the coil onto that tube end. In one embodiment, the respective end section can comprise a conical design, thereby enabling an easy way of attaching the coil onto the tubular section. In addition, the base flange of the bobbin is provided apart from that end. For instance, it can be provided near the other end of the tubular section, which is opposite to that end, onto which the pre-wound coil is attached during assembly. Alternatively, it also can be provided near a middle part of the tubular section. In any of these cases it is ensured that in an assembled state of the filter choke the pre-wound coil is arranged, and optionally slightly pressed, between the base flanges of adjacent bobbins.

Within the scope of the disclosure, it is possible that not only one, but also each of the at least two bobbins is configured such that the coil in a pre-wound status thereof is attachable on the tubular section of each of the at least two bobbins. It goes without saying in one embodiment that the opening of the tubular section—particularly the opening of each tubular section—is also present at a respective position within the base flange, such that a continuous through hole in an axial direction of each tubular section is provided, which not only is present within the tubular section, but also penetrates the base flange. The filter choke may as well comprise more than two bobbins, for instance, three or even more bobbins, which are arranged in a stacked manner one above the other and wherein adjacent bobbins are releasably fixed to each other.

The feature that one of the two core-legs is extending through the coaxially arranged openings of the stacked bobbins can mean that a single core-segment also penetrates these openings in one embodiment. However, this is only one option for a realization of the respective feature. In an alternative embodiment it is also possible that in an assembled state of the filter-choke a gap between two core-segments forming the magnetic-core is arranged between the two bobbins. In that embodiment each one of both core-segments only penetrate a single one of the openings. In a further alternative embodiment, it is also possible, that in an assembled state of the filter-choke one and/or two of the core-segments only partially penetrate(s) an opening, such that a gap formed between them is localized inside the tubular section of a particular bobbin.

The at least two bobbins are, in one embodiment, made out of an insulating material, e.g., made out of a synthetic resin material. The production process of the bobbins can comprise an injection molding process. Due to the injection molding process, small tolerances regarding the dimensions of the bobbins can be ensured, that is advantageous with regard to the reproducibility of the magnetic properties of the filter-choke. The magnetic properties of the filter-choke can be varied by changing the number of bobbins—and therefore by changing the number of pre-wound coils—actually present in the filter-choke in a modular manner. For example, if a filter-choke requires an increased inductance value, the number of stacked bobbins—and also the number of pre-wound coils—can be increased. Therefore, within the scope of the disclosure the filter-choke in one embodiment can comprise more than only two bobbins, e.g. three, four or even more bobbins. Although it is not necessary that the at least two bobbins comprise substantially the same design, it is however advantageous, because then only a single injection mold is necessary, keeping the investment at a relatively low level. However, in some application it can be advantageous to use different designs of the at least two bobbins. In this case, the different bobbin designs, for example, can be different regarding a length of their tubular sections from bobbin to bobbin, such that pre-wound coils with different winding numbers can be placed on the different tubular sections. However, it is advantageous in one embodiment to keep the lateral dimensions of the bobbin and specifically their base flanges constant.

Since the closed magnetic core is configured in one embodiment to be assembled out of at least two core segments, a labor-intensive manual production method is not required. Thus, according to the disclosure—and due to the design of the filter-choke—a production method of the filter-choke comprises the following acts: providing at least two core segments configured to be assembled to a closed magnetic core having two core-legs; providing a first bobbin and a second bobbin, wherein each bobbin comprises a base flange and a tubular section extending in perpendicular direction from the base flange, wherein the tubular section comprises an opening for receiving a first one of the two core-legs; winding an electrical conductor to form at least two coils by using an automatic winding process; arranging the pre-wound coils on the tubular section of each bobbin; arranging the first bobbin relative to the second bobbin in a stacked manner one above the other and releasably fixing the first bobbin to the second bobbin, such that their openings are oriented coaxially to each other, wherein terminals of the coils are substantially arranged in predefined positions; and inserting the core segments in the openings of the bobbins to form a closed magnetic core.

Due to the design of the filter-choke a highly automatized production method can be used. For example, an automatic winding technology can be used for winding the electrical conductor, which is advantageous for producing the coils in a highly reproducible and cost-efficient manner. This is advantageous in one embodiment if the electric conductor comprises a large cross section, which manually would be very difficult and irreproducible to wind. Since one or both of the bobbins is/are configured such that the coil is attachable on the tubular section of the respective one/ones of the at least two bobbins, and since the winding of the coils is done prior to its placement on the bobbins and on the core-legs, a mechanical stress and its jeopardizing effects on the magnetic core during winding—typically present when using a manual winding process—can be eliminated. Although in one embodiment the magnetic core is configured to be assembled out of at least two core segments and therefore comprises at least one gap, the detrimental effect of the gap on the magnetic properties of the assembled magnetic core (here: an increase of the magnetic reluctance of the magnetic core) can be reduced by designing the core segments such that they are providing a bypass path for the magnetic flux around the at least one gap in an assembled state of the magnetic core. This will be explained in more detail in FIG. 4a and FIG. 4b.

In one embodiment of the filter-choke, each bobbin comprises two tubular sections extending in a perpendicular direction from the base flange, wherein each of the tubular sections contain an opening for receiving a different one of the two core legs. The feature that each bobbin comprises two tubular sections is to be understood that in addition to the tubular section mentioned above each bobbin comprises a further tubular section that is extending in a perpendicular direction from the base flange. For each bobbin the further tubular section can be located adjacent to the tubular section. In this case the coil and a further coil, that are each formed by an electric conductor and comprising multiple windings, are arranged around each tubular section of each bobbin. Here, one of the at least two bobbins is configured such that each coil in a pre-wound status thereof is attachable, for example, attachable along an axial direction of the tubular section, on its associated one of the two tubular sections. In this embodiment in an assembled state of the filter-choke the coils are arranged, optionally in a slightly pressed manner, between the base flanges of the adjacent bobbins. It is also possible that both, or all, of the at least two bobbins are configured such that each coil in a pre-wound status thereof is attachable on the two tubular sections of each of the at least two bobbins. The two tubular sections can comprise axial directions, which are oriented substantially parallel relative to each other. This specifically can be the case if the magnetic core comprises a closed rectangular design with parallel oriented core legs on opposing sites of the magnetic core. It is also possible that the magnetic core comprises a toroidal form in its assembled state.

In one embodiment, each bobbin of the filter-choke can contain guiding elements arranged on a bottom surface and/or on a top surface of its base flange. The guiding elements can be configured to position and/or align at least one terminal—or each terminal—of the pre-wound coils formed by the electric conductor and arranged on the tubular section in an assembled state of the filter-choke. In one embodiment, each bobbin may contain guiding elements such that each terminal of each coil present in the assembled filter-choke is aligned relative to each other and arranged at predefined positions relative to the assembled filter-choke. An easy assembly of the filter-choke with other electrical components in an electric device, for example, an assembly of the filter-choke on a Printed-Circuit-Board (PCB), can be supported by the guiding elements.

In one embodiment of the filter-choke, the at least two first fitting elements of the first bobbin can be configured such that they are forming a snap fitting with the respective first fitting elements of the adjacent second bobbin in an assembled state of the filter-choke. For example, each first fitting element of the first bobbin—and also of the second bobbin—can contain a part and/or a corresponding counterpart of the snap fitting. The snap fitting can comprise a hook/loop design wherein a “hook” as the part engages with “a loop” of the corresponding counterpart of the snap fitting. For each first fitting element the snap fitting part and the snap fitting counterpart can be designed such that they are extending perpendicularly relative to the base flange and in opposite axial directions relative to each other from the edge of the base flange. In one embodiment of the filter-choke, the at least two bobbins can be designed substantially identical to each other by providing such designed parts and counterparts within each first fitting element of the bobbins. By designing the at least two bobbins substantially identical to each other, the investment in the required injection molds for producing the bobbins can be minimized. This even is the case if the at least two bobbins are differing only in the length of their respective tubular sections. Therefore, the expression “substantially identical” is meant here to also cover a design of the bobbins, which is identical for the at least two bobbins apart from different lengths of their tubular sections.

In one embodiment of the filter-choke, the base flange of one or two of the at least two bobbins, for example, an outer one of the at least two bobbins within the assembly of the filter-choke, can comprise two second fitting elements for releasably engaging with corresponding fitting elements of a core clip, wherein the core clip is configured to fix at least one—or more than one—of the multiple core segments of the magnetic core within the assembly of the filter-choke. The assembly of the filter-choke, specifically the fixing of the magnetic core segments within the subassembly of the magnetic core can easily be realized by means of the core clip(s).

In one embodiment, the filter-choke can further comprise a lid made of insulating material and have substantially the same shape as the base flange of the bobbins. For example, a peripheral shape of the lid is identical to a peripheral shape of the base flange of the bobbin. Therefore, in an assembled state of the filter choke a building space in a lateral direction needed for the lid is substantially equal to that one needed for the base flange. The lid acts, in one embodiment, as an isolating measure by which an unwanted electrical contact between the outer coil(s) and the magnetic core can be prevented. The lid can be configured to be releasably fixed to a top one—or an outer one—of the first bobbin and the second bobbin within the assembly of the filter-choke. The fixing relative to the respective bobbin can be realized by also providing respective snap fitting parts on one side of the lid, which are configured to engage with the free snap fitting counterparts of the adjacently arranged bobbin. The lid can also comprise the same number of openings at similar positions compared to each one of the bobbins within the filter-choke, such that the lid is also configured to receive the at least one core-leg—or two core-legs—of the magnetic core. However, contrary to the design of the bobbins, the lid on one side comprises a substantially flat surface design without a tubular section extending in that respective direction. On that side, however, second fitting elements can be present, which are configured to engage with corresponding fitting elements of a further core clip of the filter-choke. By providing two core clips on opposing sides of the filter-choke, the whole assembly can be securely fixed in an easy manner.

Since the magnetic core of the filter-choke is configured to be assembled from multiple core segments, a gap is present in the magnetic core, which typically increases its magnetic reluctance. Since a magnetic core having a low reluctance is often required within the relevant applications of the filter-choke the increase in magnetic reluctance is an unwanted effect. That detrimental impact is, conventionally, only slightly reduced by polishing outer surfaces of the several core segments, which in turn comprises an additional labor-intensive process. However, according to one embodiment of the present application, the magnetic core of the filter-choke can comprise a low reluctance bypass-path around the gap, optionally around each gap. Therefore, the detrimental effect can be minimized, or even eliminated, without a labor intensive polishing.

Specifically, the magnetic core of the filter-choke can comprise a gap having a gap plane normal \vec{n_{Gap}} that is oriented substantially parallel to a magnetic flux direction during operation of the filter-choke. For a closed magnetic core that is assembled from multiple core segments the magnetic flux during operation of the filter-choke, and therefore also the gap plane normal \vec{n_{Gap}}, is substantially directed in a circumferential direction or perimetral direction of the closed magnetic core. The bypass path can then comprise an overlapping region between two core segments that is arranged adjacent to the gap, wherein the overlapping region is oriented with its interface plane normal \vec{n_{OL}} substantially perpendicular to the magnetic flux during operation of the filter-choke. Since for a closed magnetic core assembled from multiple core segments the magnetic flux is substantially directed in a circumferential direction or a perimetral direction of the closed magnetic core, the interface plane normal \vec{n_{OL}} is therefore directed substantially perpendicular to a circumferential direction or a perimetral direction of the closed magnetic core. A close contact of that core segment is provided by the overlapping region between the core segments through which the magnetic flux can easily penetrate from one core segment to the other core segment. In addition, a tendency of penetration of the magnetic flux from one core segment to the other core segment is dependent on a size of the overlapping region. Specifically, the penetration is easier with an increasing area of the overlapping region. Thus, the magnetic reluctance of the bypass path, and also of the magnetic core, decreases with an area increase of the overlapping region. Therefore, by designing the geometry of the core segments, for example, their overlapping regions, a specific magnetic reluctance of the magnetic core can be designed.

The overlapping region can be formed between the two core segments that are also forming the gap (this is the case for the magnetic core disclosed in FIG. 4a). However, it is also possible that the magnetic core comprises at least three or more core segments. In that case, it is possible that the gap is formed by a first core segment and a second core segment, wherein two overlapping regions adjacent to the gap are formed, from which one overlapping region is formed between the first core segment and the third core segment, and the other overlapping region is formed between the third core segment and the second core segment (see, e.g., FIG. 4b).

In one embodiment, the magnetic core—in an assembled state of the filter-choke—can comprise at least four core segments arranged in at least two layers arranged one above the other. Each layer can contain a closed magnetic sub-core with substantially the same geometry formed out of at least two core segments, wherein the closed sub-cores are coaxially aligned to each other. In that case the core segments of the sub-cores in the different layers are arranged such that all gaps having a gap plane normal oriented substantially parallel to the magnetic flux are arranged offset to each other in the different sub-cores. A low reluctance bypass path around each gap in the first layer is directed along a core segment in the adjacent second layer and arranged above or below the gap in the first layer via this design feature. Furthermore, a low reluctance bypass path around each gap in the second layer is directed along a core segment in the adjacent first layer and arranged above or below the gap in the second layer.

Independent of whether the magnetic core comprises one of more layers and independent of whether it comprises two or more core-segments, the multiple core segments can comprise different core materials. Therefore, although each individual core-segment is formed from a single core material only, in one embodiment, the core materials of at least two individual core-segments of the multiple core-segments can be different from each other. If the magnetic core comprises multiple layers, in one embodiment, each layer can comprise a single core material only, but the core-materials of at least two different layers can be different from each other. In an alternative embodiment one, more or each layer can comprise at least two core-segments having a different core material. By choosing different core materials in the core-segments, e.g. material A in a first core segment and material B in a second core segment etc., a larger degree of freedom for achieving a targeted value for a specific magnetic property of the filter-choke can be achieved. Accordingly, the inductance of the filter choke can better be adjusted to a required value than this would be the case for a magnetic core with the same material in each core segment.

In one embodiment of the filter-choke, the electric conductor used for winding the at least two coils comprises a flat wire. Optionally, the at least two coils are formed by winding the flat wire around its thin edge. By winding a flat wire, for example, by winding a flat wire around its thin edge, a coil (also called “edge wound coil”) with a relatively low ohmic resistance combined with a relatively large winding density can be produced. This in turn results in an advantageous decrease of component size for the filter-choke. Since the DC-resistance of such “flat wire coils”, and in particular, “edge wound coils” can be kept low, they are, in one embodiment, used in filter-chokes within power electronic electric devices, e.g. DC/DC-converters or DC/AC-inverters. When using the traditional manual and labor intensive winding technology, it is often not possible to produce such edge wound coils. However, this is not a problem for the filter choke according to the present application, since the method for producing the filter-choke comprises the act of forming the coils by use of an automatic winding technology.

An electrical device according to the disclosure is characterized by including an EMI filter, which EMI filter comprises a filter-choke according to the disclosure. The filter-choke within the device can be configured to operate as one of a “differential-mode filter-choke and a “common-mode” filter-choke. The electrical device can be a power electronic device, for example, a DC/AC-inverter or a DC/DC-converter. The effects resulting for the electrical device are similar to those already described in combination with the filter-choke and the method of its production. Therefore, regarding the effects associated with the electrical device reference is made to the relevant sections.

### BRIEF DESCRIPTION OF THE DRAWINGS

The disclosure is further explained and described with respect to example embodiments illustrated in the drawings, wherein

FIG. 1a illustrates an embodiment of a bobbin that can be used in the filter-choke displayed in a front view;

FIG. 1b illustrates the bobbin of FIG. 1a displayed in a back view;

FIG. 2 illustrates embodiments of a first bobbin and a second bobbin in a preassembled state;

FIG. 3a illustrates a first embodiment of a filter-choke according to the disclosure in an exploded view;

FIG. 3b illustrates the filter-choke from FIG. 3a in an assembled state;

FIG. 4a is a schematic drawing of a gap and its low reluctance bypass path in a first embodiment of the magnetic core;

FIG. 4b is a schematic drawing of a gap and its low reluctance bypass path in a second embodiment of the magnetic core;

FIG. 5a illustrates an embodiment of a magnetic core for use in the filter-choke in an exploded view; and

FIG. 5b illustrates the magnetic core of FIG. 5a in an assembled state.

### DETAILED DESCRIPTION

The present disclosure relates to a filter-choke for use in an Electro-Magnetic-Interference—(EMI) filter. Particularly, the present disclosure relates to a filter-choke that on one hand provides highly reproduceable magnetic properties, particularly, when produced in mass production and that on the other hand is easy to assemble, even when an electric wire with a large cross section is to be used. While the filter-choke may be used in various appliances including differential mode filters and common mode filters, it is particularly intended for use as a common mode filter-choke. Additionally, the present disclosure relates to an electrical device with a respective filter-choke and a production method of the filter-choke.

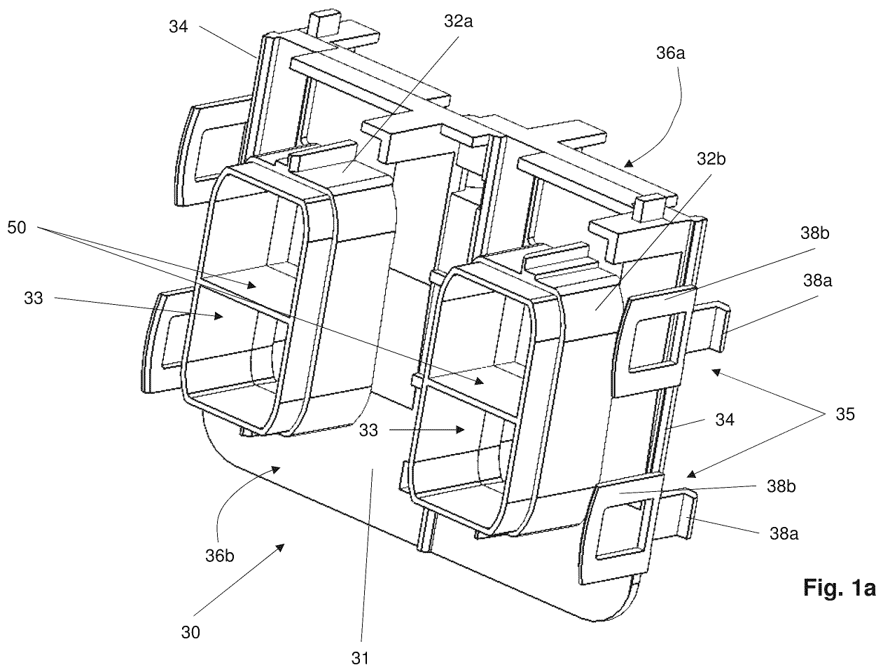

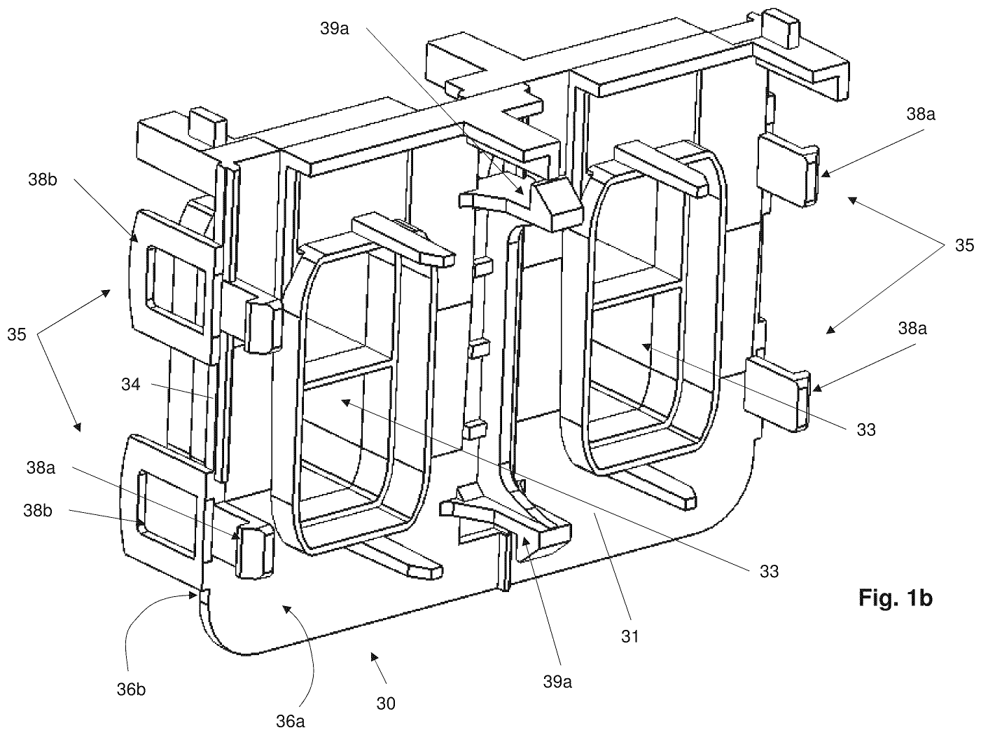

In the following, the design of an embodiment of a bobbin 30 that can be used in an embodiment of the filter-choke 10 according to the disclosure is explained in more detail. The explanation refers to FIG. 1a and FIG. 1b, wherein FIG. 1a illustrates the bobbin 30 in a front view and FIG. 1b illustrates the same bobbin 30 in a back view.

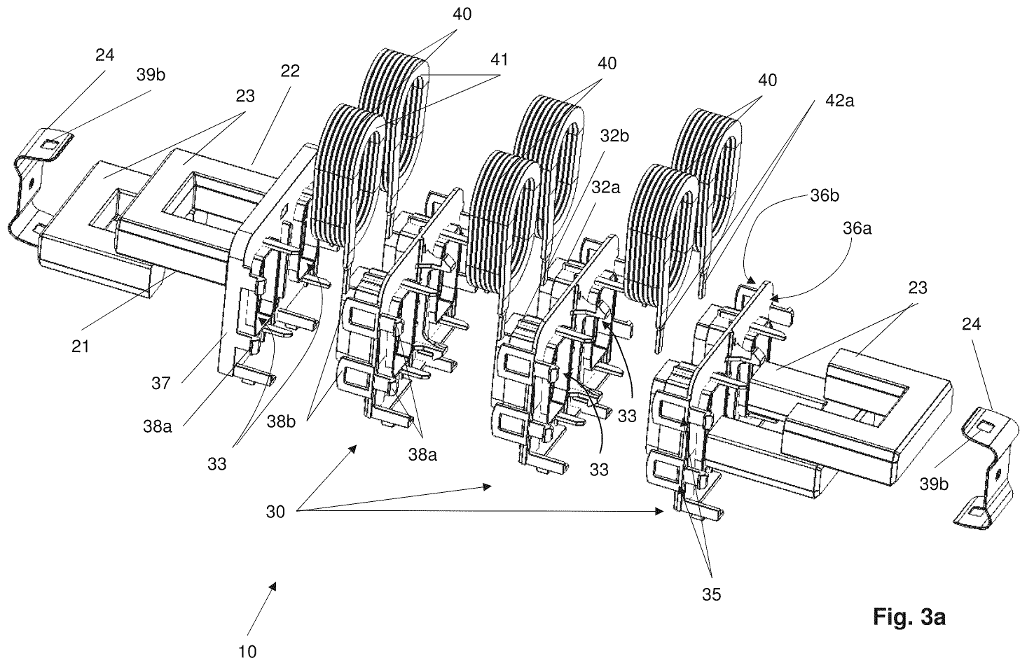

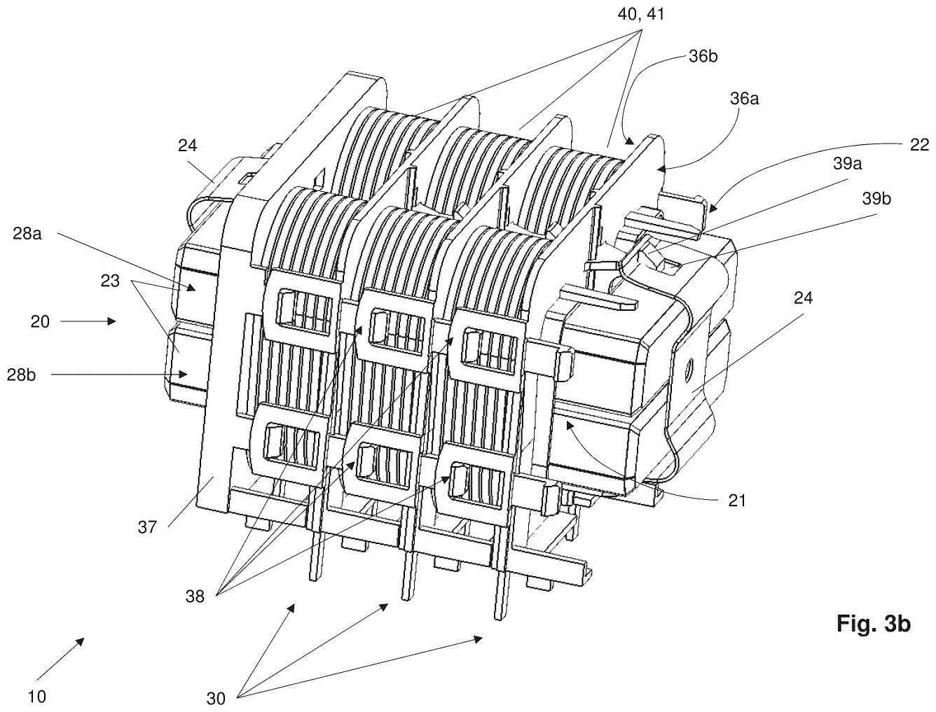

The bobbin 30 comprises a planar base-flange 31 and two tubular sections 32a, 32b extending from a front surface 36b of and in a direction perpendicular to the base flange 31. Each tubular section 32a, 32b comprises an inner opening 33. Also, the base flange 31 comprises respective openings corresponding to and aligned with the inner opening 33 of the tubular sections 32a, 32b, such that for each tubular section a continuous through-hole is provided, which also extends through the base flange 31. Each opening 33 is configured to receive a different core leg 21, 22 of the magnetic core 20 (see: FIG. 3a, FIG. 3b). Although in FIG. 1a and FIG. 1b each opening is divided by a partition wall 50, the partition wall 50 is optional. Therefore, other embodiments of the bobbin 30 may not comprise the partition walls 50 inside the openings 33.

The bobbin 30 further comprises a plurality of first fitting elements 35 arranged on opposite edges 34 of the base flange 31. By example, the bobbin 30 displayed in FIG. 1a and FIG. 1b comprises in total four first fitting elements 35, two on each opposing edge 34. The bobbin 30 is configured to releasably fix another substantially identical further bobbin relative to the bobbin 30 via the first fitting elements 35. Each first fitting element 35 includes a part 38a and a corresponding counterpart 38b of a snap fitting 38, which is formed when the first fitting elements 35 of the bobbin and the further bobbin 30 are engaging. By example, in one embodiment the snap fitting 38 is formed as a “hook-loop” snap fitting. That is why each part 38a is formed as hook, whereas the corresponding counterpart 38b is formed as a loop. However, other designs of the snap fittings are also possible, for instance a “hook-undercut” snap fitting design.

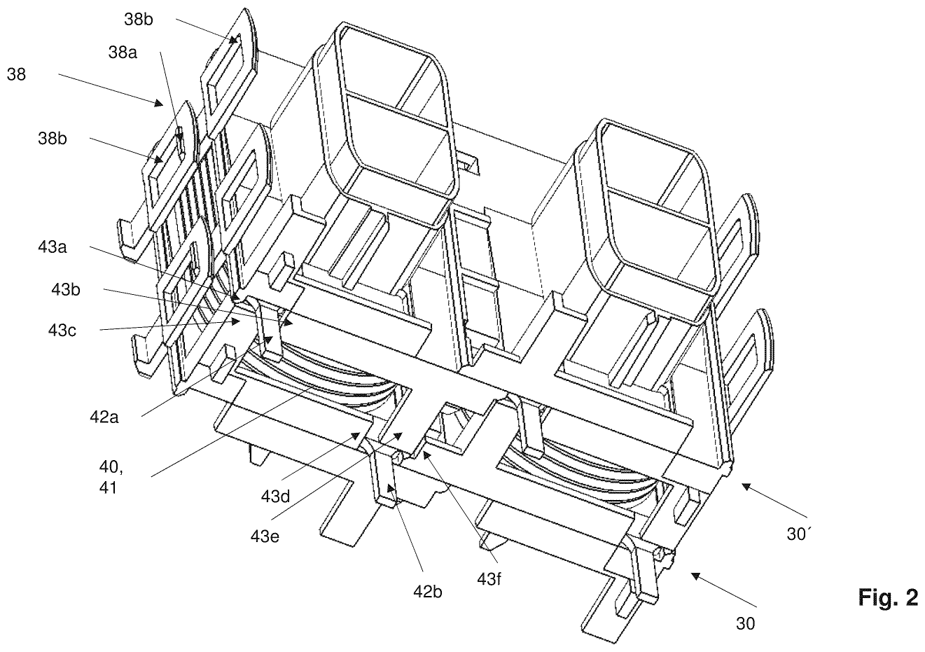

On the backside 36a of the base flange 31 two second fitting elements 39a are arranged, which—in an assembled state of the filter-choke 10 (see FIG. 3b)—are configured to engage with corresponding fitting elements 39b of a core clip 24. In addition, the front side 36b and/or the backside 36a can comprise guiding elements configured to guide and/or align coil terminals 42a, 42b of the pre-wound coils 40 within the assembled filter-choke 10, the function of which will be explained in more detail in FIG. 2.

FIG. 2 illustrates an embodiment for a preassembly of a first bobbin 30 and a second bobbin 30′ substantially identical to the first bobbin 30. Both bobbins are arranged in a stacked manner one above the other and are releasably fixed to each other via the first fitting elements 35. Specifically, each part 38a of the first fitting elements 35 of the second bobbin 30′ engages with its corresponding counterpart 38b of the first fitting elements 35 of the first bobbin 30. Two pre-wound coils 40—formed by an electric conductor 41 and arranged onto the tubular sections 32a, 32b of the first bobbin 30 prior to preassembly—are pressed and thereby fixed between the bobbins via the fixation of the bobbins 30, 30′. Each coil 40 comprises two terminals 42a, 42b, that are positioned and aligned within the preassembly via guiding elements 43a-43c and 43d-43f extending from the front and/or from the backside of each bobbin 30, 30′. In one embodiment, due to small tolerances which typically can be achieved by injection molding of the bobbins 30, 30′ the precise alignment and positioning of the terminals 42a, 42b is ensured.

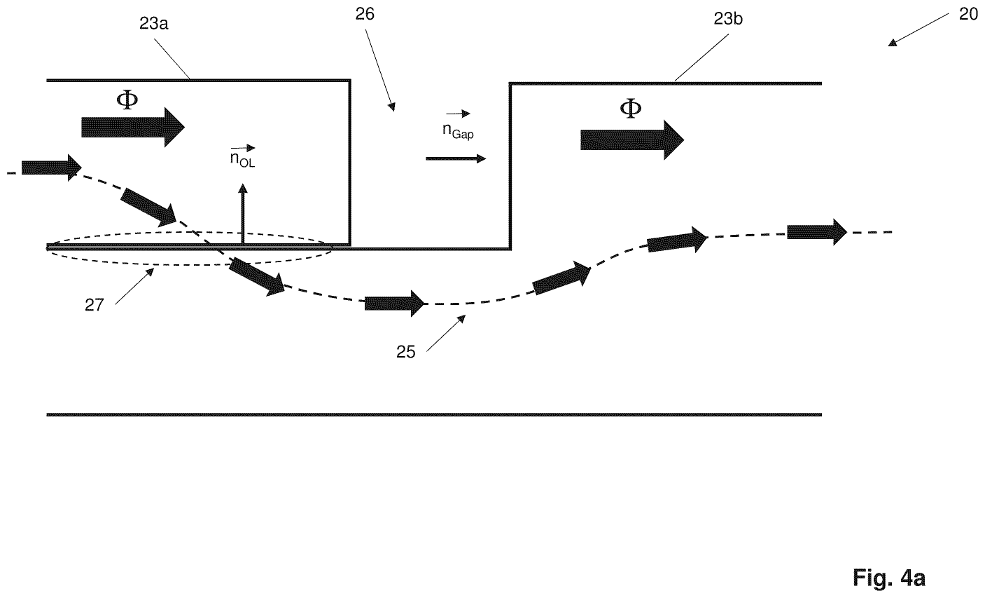

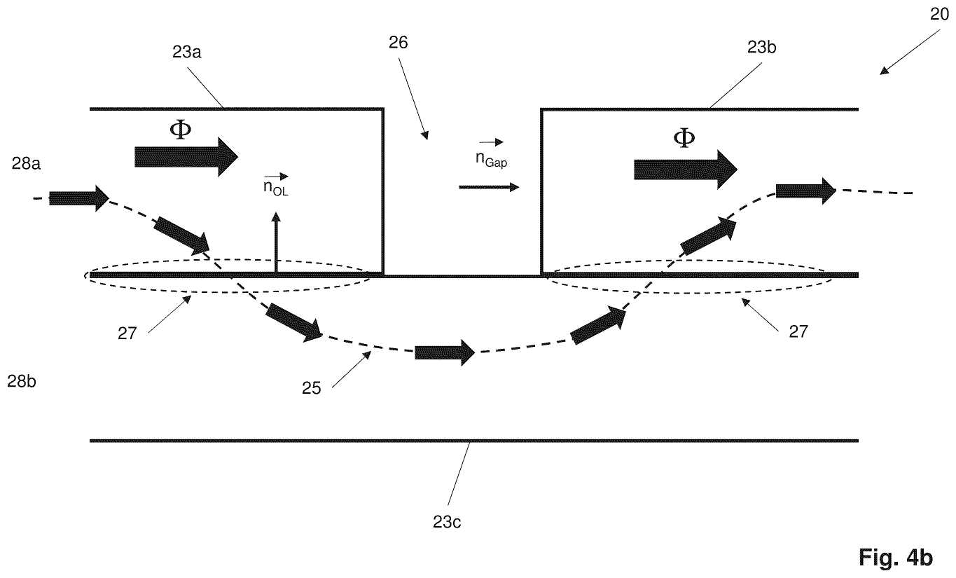

The assembly of an embodiment of the filter-choke is now explained with reference to FIG. 3a and FIG. 3b, wherein FIG. 3a illustrates the filter-choke 10 in an exploded view and FIG. 3b shows the filter-choke 10 of FIG. 3a in an assembled state. The filter-choke 10 comprises three substantially identical bobbins 30. In this embodiment each bobbin is also designed identical to the bobbin 30 shown in FIG. 1a and FIG. 1b. The filter-choke 10 further comprises six pre-wound coils 40, each comprising an electrical conductor 41 formed by a flat wire. In one example the pre-wound coils 40 are formed as so-called “edge-wound coils” which are produced by winding the flat wire 41 around its thin edge. In addition, the filter-choke 10 comprises a lid 37 configured to be attached and releasably fixed to an outer bobbin 37 (in FIG. 3a the bobbin 30 on the left side). The design of the lid 37 is similar to the design of the bobbin 30, at least with regard to its lateral dimensions as well as the geometry of its backside. The front side of the lid 37, however, is substantially planar. The lid 37 also comprises two openings 33 on corresponding positions like this is the case for the bobbins 30. Each opening 33 of the lid 37 is configured to receive a different one of the core legs 21, 22 of the magnetic core 20. The magnetic core 20 of the filter-choke 10 is formed by four U-shaped core segments 23 arranged in two adjacent layers. Each layer contains two U-shaped core segments 23, such that in an assembled state of the filter-choke 10 each layer comprises a closed magnetic sub-core 28a, 28b. The U-shaped core segments 23 are of two different lengths, such that in the assembled state of the filter-choke 10 the gaps 26 (FIG. 4a) formed within the magnetic sub-core 28a in the first layer are arranged offset relative to the gaps 26 formed within the magnetic sub-core 28b in the second layer. By means of these offset gaps and the overlapping regions formed by the core segments 23 in the different layers, a low reluctance bypass-path extends across each of the gaps 26 of the magnetic core 20. Thus, the magnetic reluctance of the magnetic core 20 can be kept relatively low, although the magnetic core comprises in total four gaps 26, each gap having a gap plane normal \vec{n_{Gap}} oriented substantially parallel to the magnetic flux within the magnetic core 20 during operation of the filter-choke 10. (See FIG. 4a).

When assembling the filter-choke 10, each coil 40 is arranged around a different one of the tubular sections 32a, 32b of the several bobbins 30. After placement of the coils 40 onto the tubular sections 32a, 32b, each bobbin 30 is releasably fixed to its adjacent bobbin 30, thereby pressing the coils 40 between adjacent bobbins and arranging/aligning the terminals 42a, 42b of the coils 40 in predefined positions relative to the whole assembly. In addition, the lid 37 is releasably fixed onto the outer bobbin 30 via corresponding parts 38a and/or counterparts 38b of snap fittings also arranged on opposing edges of the lid 37. Then, the magnetic core 20 is assembled by inserting the U-shaped core-segments 23 into the openings 33 of the lid 37 and the bobbins 30. Finally, the core segments 23 of the magnetic core are fixed relative to an outer bobbin 30 and also relative to the lid 37 by releasably fixing one of two core clips 24 on each opposing side of the filter-choke 10.

In the following, the operating principle of the low reluctance bypass path 25 is explained in more detail. Specifically, FIG. 4a represents a schematic drawing of a magnetic core 20 section according to a first embodiment of the magnetic core 20. The section shows a gap 26 that is formed by a first core segment 23a and a second core segment 23b. The gap 26 comprises a gap plane normal \vec{n_{Gap}} that is oriented substantially parallel to the magnetic flux ϕ, the direction of which is symbolized by bolt arrows in the core segments 23a, 23b. Without countermeasures, the gap 26 normally would result in an increase of the magnetic reluctance of the magnetic core 20. However, as depicted in FIG. 4a both adjacent core segments 23a, 23b are designed such that an overlapping region 27 is provided adjacent to the gap 26. The overlapping region 27 is oriented such that its plane normal \vec{n_{OL}} is directed substantially perpendicular to the direction of the magnetic flux ϕ during operation of the filter-choke 10. In the overlapping region 27 a close contact between both core segments 23a, 23b over a relatively large surface area (at least larger than an area associated with the gap 26) can be provided. Therefore, within the overlapping region 27 there is a lower resistance for a penetration of the magnetic flux ϕ from the first core segment 23a to the second core segment 23b and vice versa, at least significantly lower as it would be for a penetration through the gap 26. This results in a low reluctance bypass path 25 around the gap 26 as symbolized in FIG. 4a by the small arrows and the dotted line.

The resistance for penetration of the magnetic flux ϕ in the overlapping region 27 is dependent on its lateral dimensions—the resistance typically decreases with increasing lateral dimensions of the overlapping region 27—and thus can easily be varied by a targeted design of the core segments 23a, 23b relative to each other.

FIG. 4b represents a schematic drawing of a gap 26 and its low reluctance bypass path 25 in a second embodiment of the magnetic core 20. The situation is similar to the situation illustrated in FIG. 4a. However, in the embodiment in FIG. 4b the magnetic core 20 comprises two adjacent layers, wherein in each layer a closed magnetic sub-core 28a, 28b is provided, such that the closed sub-cores 28a, 28b are stacked one above the other. Although each sub-core 28a, 28b represents a closed magnetic sub-core, gaps 26 are present due to the fact that each sub-core 28a, 28b is formed by at least two core segments 23a, 23b (in the first layer 28a) and 23c, 23d (not illustrated in FIG. 4b) in the second layer 28b. The gaps 26 in the different sub-cores 28a, 28b are arranged offset to each other, such that adjacent to a gap in one of the sub-cores 28a, 28b, there is always a continuous section of a core segment 23 of the other of the sub-cores 28b, 28a. FIG. 4b depicts the situation around such a gap 26 in the first layer 28a (in FIG. 4b the first layer) by example.

Adjacent to the gap 26 and on each of its site overlapping regions 27 between two different core segments 23a-23c are formed. For example, in FIG. 4b, on one side of the gap 26 an overlapping region 27 between the first core segment 23a and the third core segment 23c is formed, whereas on the other site of the gap 26 a further overlapping region 27 between the second core segment 23b and the third core segment 23c is formed. Based on the explanation provided in conjunction with FIG. 4a, this results in a low reluctance bypass path around the gap 26 starting on one side of the gap 26 in the first core segment 23a, through the overlapping region 27 via the third core segment 23c and through the further overlapping region 27 into the second core-segment 23b, and vice versa. In this embodiment the low reluctance bypass path 25 is guided around the gap 26 through a core section 23c, 23d of the magnetic sub-core in an adjacently arranged sub-core 28a, 28b, i.e. the sub-cores 28a, 28b in the adjacent layers. If more than two sub-cores 28a 28b or layers are provided within the magnetic core 20, a respective bypass path 25 around a gap 26 is present in each adjacent sub-core 28a, 28b.

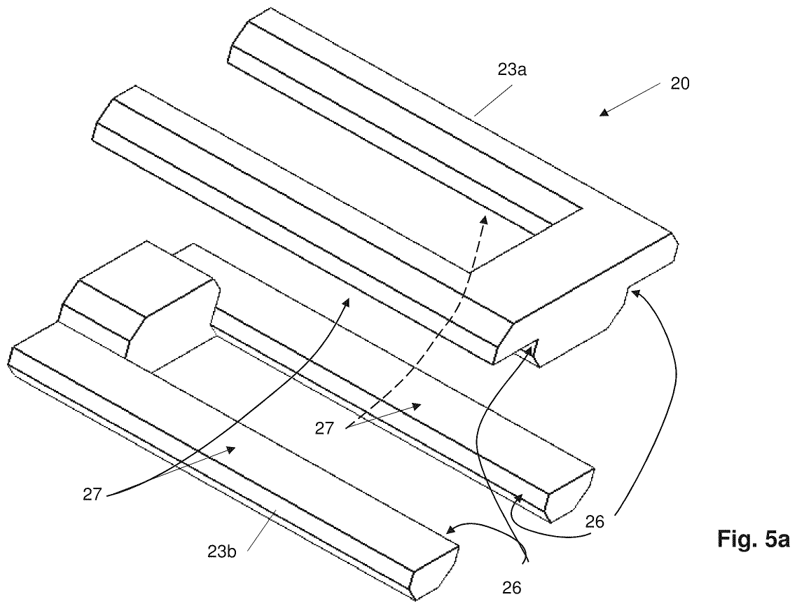

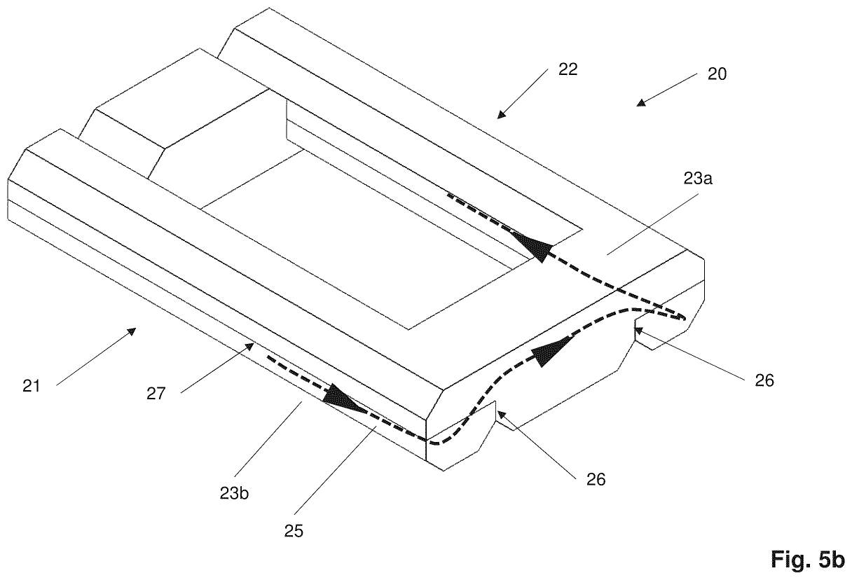

In the following, an alternative embodiment of a magnetic core 20 compared to that illustrated in FIG. 3a and FIG. 3b is explained. For the explanation it is referred to FIGS. 5a and 5b, wherein FIG. 5a illustrates the magnetic core 20 in an exploded view and FIG. 5b in a preassembled state. The magnetic core 20 is formed by two core segments 23. Each core-segment 23a, 23b comprises a U-shape design comprising two U-legs and a U-base having a thickened middle region. In a preassembled state of the core segments 23a, 23b a closed magnetic core 20 having a rectangular geometry (as seen from a top view) is formed. Further, in the preassembled state of the magnetic core 20 in FIG. 5a, 5b, two gaps 26 between the two core segments 23a, 23b are formed on each U-base (in other words: on each short side of the magnetic core 20). Further, two overlapping regions 27 are formed in the preassembled state, which overlapping regions 27 extend along the U-legs (in other words: along the core-legs 21, 22). Keeping in mind the explanation provided in FIGS. 3a this results in a magnetic bypass path 25 around each gap 26 as schematically illustrated in FIG. 5b for two (of four) gaps 26 on one short side of the magnetic core 20.

Although the magnetic core 20 in FIGS. 5a, 5b is configured to be used as a magnetic core only having a single layer, it is alternatively also possible to form a magnetic core 20 comprising multiple of such magnetic cores as magnetic sub-cores 28a, 28b, wherein each sub-core 28a, 28b is arranged in a single one of the plurality of layers.

What is claimed is:

1. A filter-choke to be used in an EMI filter, the filter choke comprising:
a closed magnetic core comprising two core-legs, wherein the magnetic core is configured to be assembled out of at least two core segments,
at least two bobbins, each bobbin comprising a base flange and a tubular section extending in a perpendicular direction from the base flange, wherein the tubular section comprises an opening for receiving one of the two core-legs,
a coil formed by an electric conductor having multiple windings arranged around the tubular section of each bobbin, thereby comprising at least a first coil and a second coil, respectively, for the at least two bobbins,
wherein a first one of the at least two bobbins is configured such that the first coil in a pre-wound state thereof is attachable on the tubular section of a respective one of the at least two bobbins, and wherein in an assembled state of the filter-choke, the at least two bobbins are arranged in a stacked manner, such that their openings are aligned coaxially with each other, with one of the core legs extending through the openings, and wherein each bobbin comprises at least two first fitting elements arranged on opposite edges of its base flange, wherein the first fitting elements of the first bobbin are configured to engage with the first fitting elements of the adjacent second bobbin for releasably fixing the two bobbins together, and wherein the first coil is arranged between the base flanges of the first bobbin and the adjacent second bobbin.

2. The filter-choke according to claim 1, wherein each bobbin comprises two tubular sections extending in the perpendicular direction from the base flange, such that the first bobbin has a first pair of first coils attachable to a respective pair of first tubular sections, and the second bobbin has a second pair of second coils attachable to a respective pair of second tubular sections, wherein each of the tubular sections contains an opening for receiving a different one of the two core legs, respectively, and wherein a coil formed by an electric conductor having multiple windings is arranged around each tubular section of the bobbin, wherein the first one of the at least two bobbins is configured such that each first coil of the first pair of coils in a pre-wound status thereof is attachable on its associated one of the two tubular sections, and wherein in an assembled state of the filter-choke the first coils of the first pair of coils are arranged between the base flanges of the adjacent bobbins.

3. The filter-choke according to claim 1, wherein each bobbin comprises guiding elements arranged on a bottom surface and/or a top surface of its base flange for positioning and/or aligning at least one terminal of the coil formed by the electric conductor.

4. The filter-choke according to claim 1, wherein the at least two first fitting elements each comprise a part and/or a corresponding counterpart configured to form a snap fitting with the adjacent second bobbin.

5. The filter-choke according to claim 4, wherein for each first fitting element the snap fitting part and the snap fitting counterpart extend in opposite axial directions from an edge of the base flange.

6. The filter-choke according to claim 1, wherein the base flange of one of the at least two bobbins comprises two second fitting elements configured to releasably engage with corresponding second fitting elements of a core clip configured to fix at least one of the multiple core segments of the magnetic core.

7. The filter-choke according to claim 1, further comprising a lid made of insulating material and having substantially the same shape as the base flange of the bobbins, wherein the lid is releasably fixed to an outer one of the first bobbin and the second bobbin.

8. The filter-choke according to claim 1, wherein the magnetic core comprises a low reluctance bypass path around a gap, wherein the gap comprises a gap plane normal that is oriented substantially parallel to a magnetic flux direction during operation of the filter-choke, and wherein the bypass path further comprises an overlapping region between two core segments that are arranged adjacent to the gap, and wherein the overlapping region is oriented with its interface plane normal substantially perpendicular to the magnetic flux direction during operation of the filter-choke.

9. The filter-choke according to claim 1, wherein the magnetic core comprises at least four core segments arranged in at least two layers, such that each layer contains a closed magnetic sub-core with substantially the same geometry formed out of at least two core segments, wherein the magnetic sub-cores are coaxially aligned to each other.

10. The filter-choke according to claim 9, wherein the core segments of the sub-cores in the different layers are arranged such that those gaps that are oriented with their gap plane normal substantially parallel to the magnetic flux are arranged offset to each other in the different sub-cores.

11. The filter-choke according to claim 1, wherein the electric conductor comprises a flat wire.

12. The filter-choke according to claim 1, wherein the multiple core segments comprise different core materials.

13. The filter-choke according to claim 1, wherein the at least two bobbins are substantially identical to each other.

14. An electric device including a filter-choke, comprising:
a closed magnetic core comprising two core-legs, wherein the magnetic core is configured to be assembled out of at least two core segments,
at least two bobbins, each bobbin comprising a base flange and a tubular section extending in a perpendicular direction from the base flange, wherein the tubular section comprises an opening for receiving one of the two core-legs,
a coil formed by an electric conductor having multiple windings arranged around the tubular section of each bobbin, thereby comprising at least a first coil and a second coil, respectively, for the at least two bobbins,
wherein a first one of the at least two bobbins is configured such that the first coil in a pre-wound state thereof is attachable on the tubular section of the respective one of the at least two bobbins, and in that in an assembled state of the filter-choke, the bobbins are arranged in a stacked manner, such that their openings are aligned coaxially to each other, one of the core legs extending through the openings, and wherein each bobbin comprise at least two first fitting elements arranged on opposite edges of its base flange, wherein the first fitting elements of the first bobbin are configured to engage with the first fitting elements of an adjacent second bobbin for releasably fixing the two bobbins together, and wherein the first coil is arranged between the base flanges of the first bobbin and the adjacent second bobbin, and
wherein the filter-choke is operated within the electrical device as a common-mode choke.

15. A method of producing a filter-choke that comprises:
a closed magnetic core comprising two core-legs, wherein the magnetic core is configured to be assembled out of at least two core segments,
at least two bobbins, each bobbin comprising a base flange and a tubular section extending in a perpendicular direction from the base flange, wherein the tubular section comprises an opening for receiving one of the two core-legs,
a coil formed by an electric conductor having multiple windings arranged around the tubular section of each bobbin, thereby comprising at least a first coil and a second coil, respectively, for the at least two bobbins,
wherein a first one of the at least two bobbins is configured such that the first coil in a pre-wound state thereof is attachable on the tubular section of the respective one of the at least two bobbins, and in that in an assembled state of the filter-choke, the bobbins are arranged in a stacked manner, such that their openings are aligned coaxially to each other, one of the core legs extending through the openings, and in that each bobbin comprise at least two first fitting elements arranged on opposite edges of its base flange, wherein the first fitting elements of the first bobbin are configured to engage with the first fitting elements of an adjacent second bobbin for releasably fixing the two bobbins together, and wherein the first coil is arranged between the base flanges of the first bobbin and the adjacent second bobbin, the method comprising:
providing at least two core segments configured to be assembled to a closed magnetic core having two core-legs,
providing a first bobbin and a second bobbin, wherein each bobbin comprises a base flange and a tubular section extending in perpendicular direction from the base flange, and wherein the tubular section comprises an opening for receiving one of the two core-legs,
winding an electrical conductor to form at least two coils by using an automatic winding process,
arranging the pre-wound coils on the tubular section of each bobbin,
arranging the first bobbin relative to the second bobbin in a stacked manner one above the other and latching the first bobbin to the second bobbin, such that their openings are oriented coaxially to each other, wherein terminals of the coils are substantially arranged in predefined positions,
inserting the core segments in the openings of the bobbins to form a closed magnetic core.
